(19) United States
(12) Patent Application Publication
(10) Pub. No.: US 2004/0020015 A1
(43) Pub. Date: Feb. 5, 2004

(54) Pivot Hinge assembly and folding pivot door assembly using the same

(76) Inventors: Takahiro Yokemura, Fukaya-shi (JP); Yoneharu Kuwabara, Honjo-shi (JP); Tetsuji Kanno, Honjo-shi (JP)

Correspondence Address: Herbert B. Keil, KEIL & WEINKAUF, 1350 Connecticut Ave., N.W., Washington, DC, 20036, US

(21) Appl. No.: 10/619,422

(22) Filed: Jul. 16, 2003

(30) Foreign Application Priority Data
Jul. 30, 2002 (JP) 2002-221323

(51) Int. Cl. E05D 15/00

(52) U.S. Cl. 16/362

(57) ABSTRACT

A pivot hinge assembly for pivotably supporting a linking column that pivots in linkage with a door in a door opening, and a folding pivot door assembly having such a hinge assembly are disclosed. The pivot hinge assembly includes a pivot pin, an elastic member urging the pivot pin downwards, a pivot pin holder having a through hole including a lower section for supporting the pivot pin vertically slidably and an upper section for accommodating the elastic member, and a closure for closing the upper end of the through hole. The elastic member is arranged with its upper end abutting the closure and its lower end abutting an upper face of the pivot pin for urging the pivot pin downward into engagement with a dent in the upper end face of the linking column.

### FIELD OF INVENTION

The present invention relates to a pivot hinge assembly and a folding pivot door assembly using the same, in particular a folding pivot door assembly that requires only a small space for opening and closing of the door.

### BACKGROUND ART

Folding pivot door assemblies are conventionally known. For example, JP-2001-288952-A of the applicants of the present application discloses one of such folding pivot door assemblies, which is shown in FIGS. 6 and 7. In these figures, folding pivot door assembly 70 includes doorplate 74, which is pivotably and slidably supported in door opening 73 defined by header 76, jambs 77a, 77b, and floor 78, by means of folding pivot mechanism 75. The mechanism 75 includes linking column 81 having upper and lower arms 79 and 80 extending horizontally from its respective ends, upper rail 82 fixed on the underside of the header 76, and guide member 83 attached to the upper face of the door plate 74 in its middle portion for engaging the rail 82.

The linking column 81 is placed in the door opening 73, and hingedly attached to the jamb 77b by means of hinges 84. When the column 81 pivots, the upper and lower arms 79 and 80 swing in a horizontal plane around the hinges 84. The free end of the upper arm 79 is pivotably connected to the upper face of the door plate 74 via upper pivot member 85, and similarly the free end of the lower arm 80 is pivotably connected to the lower face of the door plate 74 via lower pivot member 86.

When the door is pushed open from the state shown in FIG. 6, the door plate 74 pivots around the pivot members 85 and 86 acting as the pivot axis for the door plate 74, with the upper and lower arms 79 and 80 of the linking column 81 swinging around the hinges 84 in the direction opposite to the motion of the leading edge of the door plate 74, i.e. swinging forward, while the guide member 83 slides along the upper rail 82 to guide the sliding motion of the door plate 74.

The linking column 81 may alternatively be supported in the door frame by means of pivot hinge assemblies, instead of the hinges 84. In this case, the pivot hinge assemblies are provided at the upper and lower ends of the column 81 for connecting the column 81 to the header 76 or upper rail 82, and to the floor 78.

An example of such a pivot hinge assembly provided at the upper end of the column 81 is shown in FIG. 8. Pivot hinge assembly 90 includes pivot pin 94 having flange 94a in its lower portion, pivot pin holder 95 having a through hole for slidably receiving the upper portion of the pivot pin 94 therein, spring 96 disposed around the pivot pin 94 in its middle portion, and bushing hole 97 provided in the upper end face of the column 81. The pivot pin 94 is inserted and slidably held in its upper portion in the through hole of the holder 95, and is provided on its upper end with screw 92 and washer 93 for preventing the pin 94 from falling through the through hole. The spring 96 is disposed between the flange 94a and the pivot pin holder 95, and downwardly urges the pivot pin 94 on the flange 94a so that the lower portion 94b of the pin 94 below the flange 94a is urged into and received in the bushing hole 97.

In the pivot hinge assembly 90, the spring 96 is arranged around the pivot pin 94, so that, in order to receive the upper end of the spring 96, the pivot pin holder 95 has dent 95a in its lower surface. Accordingly, the pivot pin 94 is held by the pivot pin holder 95 only in section A shown in FIG. 8, while the pin 94 is not held by the holder 95 in section B. The longer the section B is, the more horizontal bending moment is to be applied to the pivot pin 94 by the linking column 81 during the operation of the folding pivot door assembly. Such bending moment causes bending of the pivot pin 94 and/or damaging of the pivot pin holder 95.

### SUMMARY OF THE INVENTION

It is therefore an object of the present invention to provide a pivot hinge assembly wherein the bending moment applied to the pivot pin is reduced, and the pivot pin and the pivot pin holder are not easily damaged to achieve improved durability.

It is another object of the present invention to provide a folding pivot door assembly having a pivot hinge assembly of improved durability.

According to the present invention, there is provided a pivot hinge assembly for pivotably supporting a linking column in a door opening around a pivot axis located near a jamb of a door frame defining the door opening, said linking column pivoting in linkage with a door plate supported in said door opening, said pivot hinge assembly comprising:

a pivot pin acting as a pivot axis for a linking column,

an elastic member urging said pivot pin downwards,

a pivot pin holder having a through hole for accommodating said elastic member and said pivot pin therein, said through hole having a lower section for supporting said pivot pin vertically slidably, and an upper section for accommodating said elastic member, and

a closure for closing an upper end of said through hole,

wherein said elastic member is arranged with its upper end abutting said closure and its lower end abutting an upper face of said pivot pin for urging said pivot pin downward into engagement with a dent provided in an upper end face of said linking column.

With the structure of the pivot hinge assembly of the present invention, the portion of the pivot pin which extends out of the pivot pin holder is made shorter than the conventional structure, which reduces the bending moment applied to the pivot pin. The bending moment applied to the pivot pin in the horizontal direction via the linking column and its dent in which the pivot pin engages, is proportional to the length of the portion of the pivot pin which extends out of the pivot pin holder. Thus, shortening of the exposed portion of the pivot pin reduces the bending moment applied to the pivot pin. Accordingly, the pivot pin and the pivot pin holder of the present invention are hard to be damaged, which results in improved durability of the pivot hinge assembly.

The pivot pin may have a body section, a flange provided at an upper end of the pin, and a reduced diameter section having a diameter smaller than that of the body section in the lower portion of the pin. The reduced diameter section may be urged downwards by the elastic member into engagement with the dent in the upper end face of the linking column.

The lower section of the through hole in the pivot pin holder may have an inner diameter slightly larger than the diameter of the pivot pin accommodated therein, so that the pivot pin may smoothly slide in the vertical direction in the through hole.

The upper section of the through hole in the pivot pin holder may have an inner diameter larger than the inner diameter of the lower section of the through hole, so that the flange of the pivot pin may smoothly slide in the upper section, and rest on the bottom of the upper section in its lower most position.

According to the present invention, there is also provided a folding pivot door assembly having the above-mentioned pivot hinge assembly comprising:

a door plate pivotably supported in a door opening defined by a door frame,

an upper rail fixed on an underside of a header of said door frame,

a linking column having upper and lower arms integrally fixed at its upper and lower ends, respectively, in a cantilever fashion, said upper and lower arms pivotably connected to the upper and lower faces of the door plate in their free end portions, respectively, said linking column pivoting in linkage with the door plate,

upper and lower pivot hinge assemblies for pivotably supporting the linking column in the door opening around a pivot axis located near a jamb of the door frame, and

a guide member fixed to and extending upwardly from the upper face of the door plate, said guide member being slidably supported by said upper rail,

wherein said upper pivot hinge assembly further comprises:

a pivot pin acting as said pivot axis for the linking column,

an elastic member urging said pivot pin downwards,

a pivot pin holder having a through hole for accommodating said elastic member and said pivot pin therein, said through hole having a lower section for supporting said pivot pin vertically slidably, and an upper section for accommodating said elastic member, and

a closure for closing an upper end of said through hole,

wherein said elastic member is arranged with its upper end abutting said closure and its lower end abutting an upper face of said pivot pin for urging said pivot pin downward into engagement with a dent provided in an upper end face of said linking column.

The folding pivot door assembly of the present invention employs the pivot hinge assembly of the present invention as its upper pivot hinge assembly. Thus improved durability of the door assembly may be achieved.

The closure may be any member as long as it closes the upper end of the through hole and provides a surface for the elastic member to abut. When the pivot pin holder is attached to the underside of the header of the door frame, the closure may be the header, with one end of the elastic member abutting the underside of the header. When the pivot pin holder is attached to the upper rail, the closure may be the upper rail, with one end of the elastic member abutting the underside of the upper rail.

### BRIEF DESCRIPTION OF THE DRAWINGS

Byway of example, preferred embodiments of the present invention will now be described with reference to the accompanying drawings, in which:

FIG. 1 is a schematic explanatory front view of an embodiment of the folding pivot door assembly according to the present invention;

FIG. 2 is a schematic explanatory plan view of the door assembly of FIG. 1, illustrating the motion of the door in opening and closing, with some parts of the folding pivot mechanism, such as upper arm and upper rail, removed for the sake of clarity;

FIG. 3 is an enlarged longitudinal sectional view of an embodiment of the pivot hinge assembly according to the present invention;

FIG. 4 is an enlarged, explanatory rear view of the upper right corner of the folding pivot door assembly of FIG. 1, partially fragmented, illustrating the pivot hinge assembly of FIG. 3, with some parts removed for the sake of clarity;

FIG. 5 is an enlarged longitudinal sectional view of the guide member of the folding pivot door assembly of FIG. 1;

FIG. 6 is a schematic front view of a conventional folding pivot door assembly;

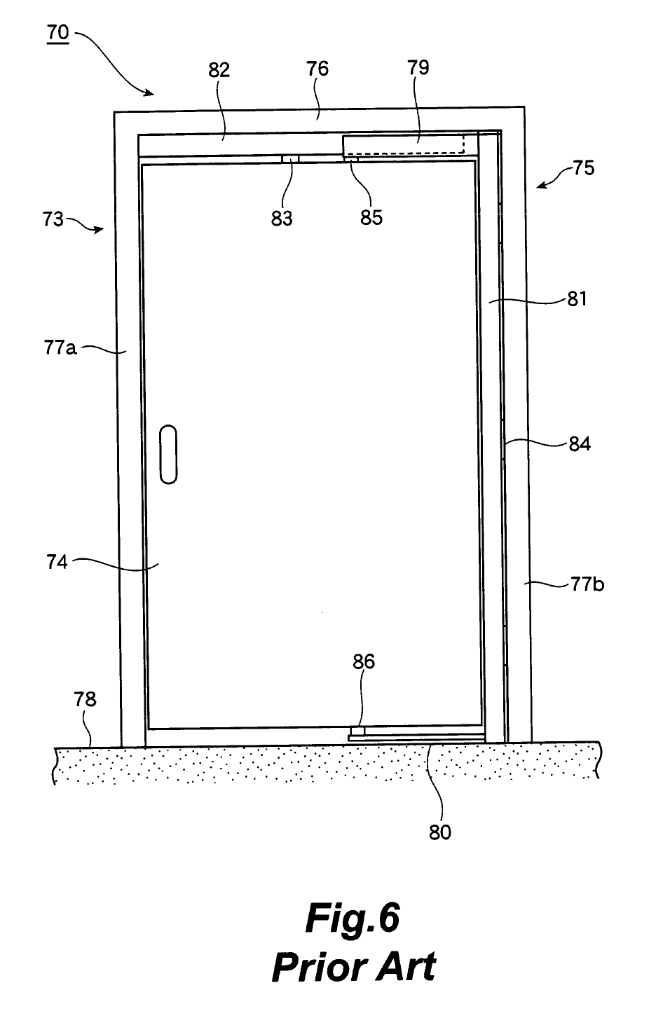

FIG. 7 is an enlarged cross sectional view of the folding pivot door assembly of FIG. 6; and

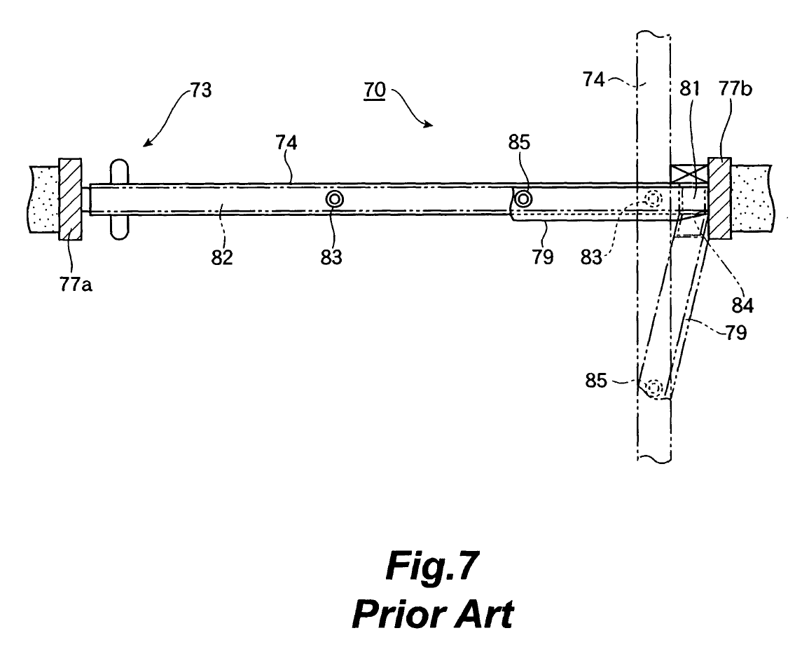

FIG. 8 is an enlarged longitudinal sectional view of a conventional pivot hinge assembly.

### PREFERRED EMBODIMENTS OF THE INVENTION

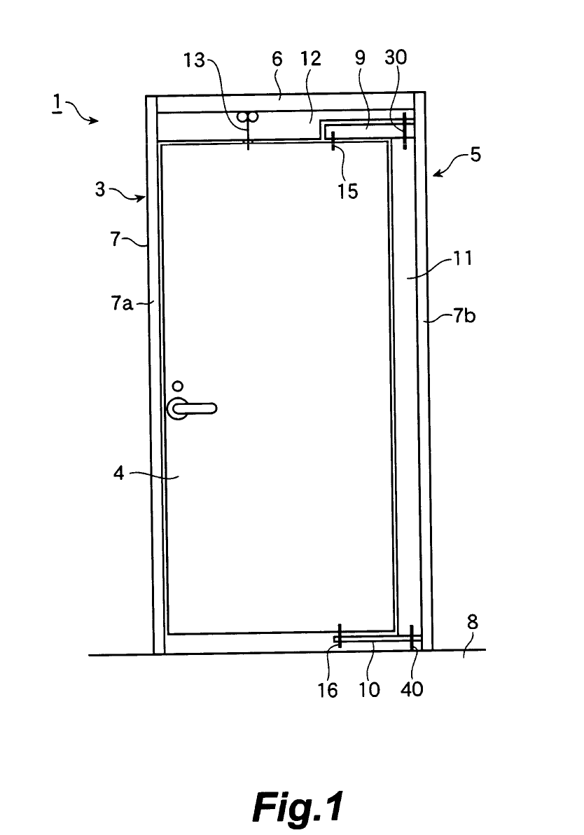

Referring to FIG. 1, folding pivot door assembly 1 includes door plate 4 and folding pivot mechanism 5. The door plate 4 is pivotably supported by means of the folding pivot mechanism 5 in door opening 3 defined by header 6 and jambs 7a, 7b of door frame 7, and floor 8. The folding pivot mechanism 5 includes upper rail 12 fixed on the underside of the header 6, linking column 11 having upper and lower arms 9 and 10 integrally fixed at its upper and lower ends, respectively, upper and lower pivot hinge assemblies 30 and 40 for pivotably supporting the linking column 11, and guide member 13 fixed to and extending upwardly from the upper face of the door plate 4.

The linking column 11 with the upper and lower arms 9 and 10, is pivotably connected to the upper rail 12 by means of the upper pivot hinge assembly 30 at its upper end, and to the floor 8 by means of the lower pivot hinge assembly 40 at its lower end.

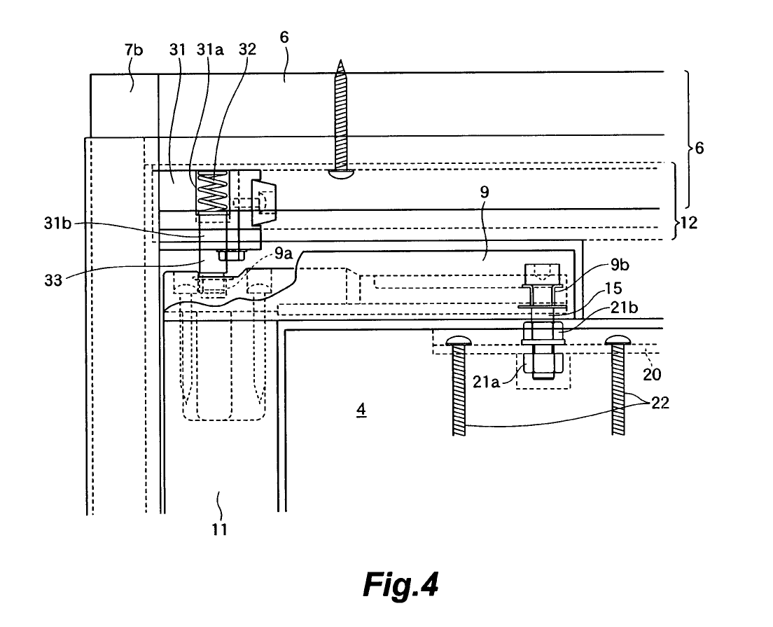

The upper arm 9 extends substantially horizontally, and pivotably connected in its free end portion to the upper face of the door plate 4 by means of upper pivot pin 15. Specifically, as shown in FIG. 4, in the free end portion of the upper arm 9 is provided a through hole 9b, into which the pivot pin 15 having an enlarged head is inserted from the above. The enlarged head of the pin 15 abuts the entry of the through hole 9b, and the pin 15 is rotatably supported in the hole 9b. The lower end of the pin 15 is securely fixed to the door plate 4 by means of attachment plate 20 fixed in the upper face of the door plate 4 with screws 22, and two nuts 21a and 21b arranged on either side of the plate 20. The lower end of the pivot pin 15 is screwed through the attachment plate 20 into the nut 21a welded to the underside of the attachment plate 20, and fastened with the nut 21b, to thereby fixing the pivot pin 15 to the attachment plate 20.

Similarly, the lower arm 10 extends substantially horizontally, and pivotably connected in its free end portion to the lower face of the door plate 4 by means of lower pivot pin 16. The lower pivot pin 16 may be, though not shown in the drawings, a projection extending upwardly from the upper face of the lower arm 10 in its free end portion, and rotatably received in a complementary bushing provided in the lower face of the door plate 4.

The upper pivot hinge assembly 30 is the pivot hinge assembly of the present invention, so that it will be discussed in detail later.

The lower pivot hinge assembly 40 may be of a conventional structure and thus not shown in detail in the drawings. However, an example of such a pivot hinge assembly may include a combination of an L-shaped metal piece having a projection on one of its legs and through holes in the other leg, and bushing having a dent or an aperture for receiving the projection. The leg of the L-shaped metal piece with the holes may be secured to the jamb 7b with screws, and the other leg placed on the floor 8 with the projection oriented upward. The bushing may be secured on the underside of the lower arm 10 so that the projection rotatably fits in the dent or aperture.

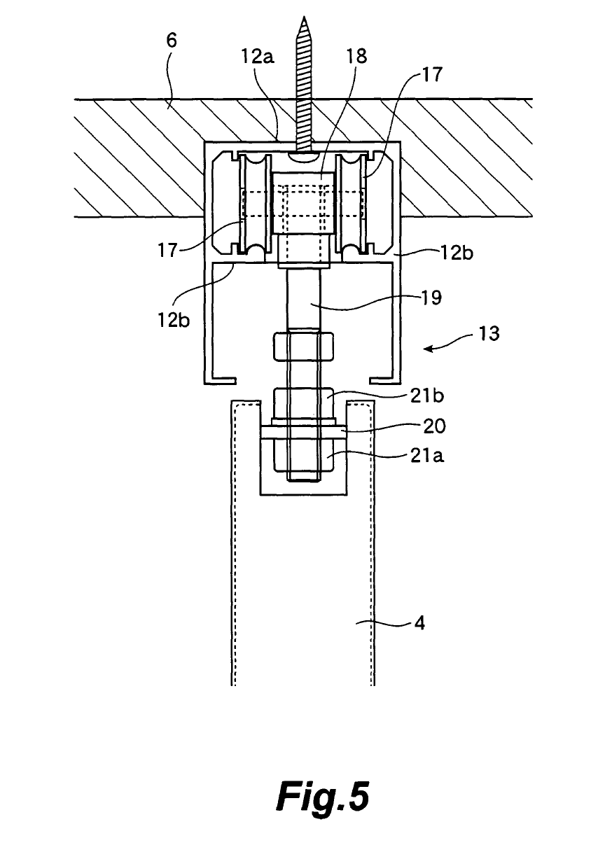

The guide member 13 may be of a conventional structure, and an example of this member 13 is shown in FIG. 5. The guide member 13 cooperates with the upper rail 12 having two tracks 12b to guide the door plate 4 when it opens and closes. Specifically, the guide member 13 has two rollers 17 for running on each track 12b, i.e. a total of four rollers 17, support block 18 for rotatably supporting the rollers 17, shaft 19 rotatably connected to and suspending from the center of the support block 18, and attachment plate 20 fixed in the upper face of the door plate 4 with small screws. On the underside of the attachment plate 20 is welded nut 21a, and the lower end of the shaft 19 is threaded through the plate 20 into the nut 21a and further fastened with nut 21b on the other side of the attachment plate 20, so that the shaft 19 is securely attached to the attachment plate 20. When the door plate 4 is pivotably opened and closed, the rollers 17 run on the tracks 12b to guide the door plate 4 along the upper rail 12, with the shaft 19 rotating with respect to the support block 18.

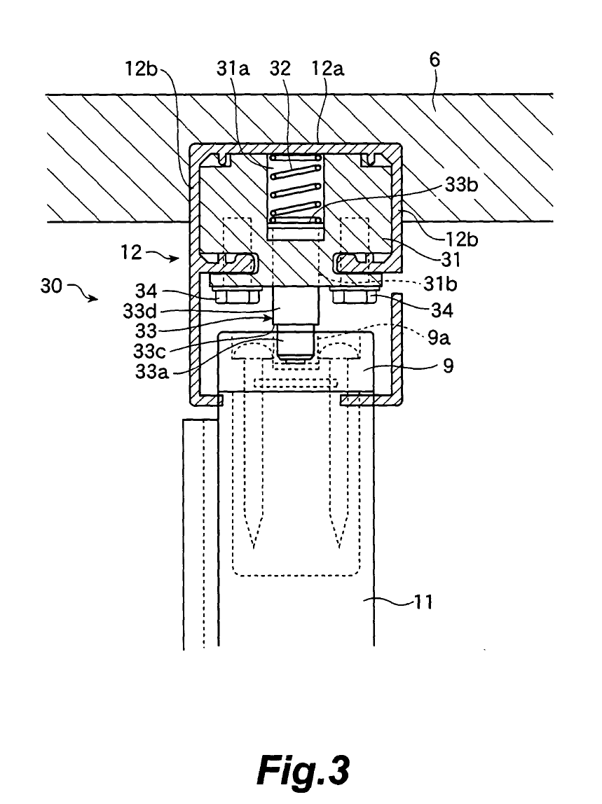

Referring to FIGS. 3 and 4, the upper pivot hinge assembly 30 is disposed in the upper rail 12 having attachment portion 12a fixed to the header 6 and a pair of tracks 12b suspending from the attachment portion 12a. The upper pivot hinge assembly 30 includes pivot pin 33 acting as the pivot axis for the linking column 11, spring 32 urging the pivot pin 33 downwards, and a pivot pin holder 31 having a vertical through hole for accommodating the pivot pin 33 and the spring 32 therein.

The pivot pin 33 has body section 33d, flange 33b provided at the upper end of the pin 33, and reduced diameter section 33a having the diameter smaller than that of the body section 33d in the lower portion of the pin 33. Step 33c is formed between the body section 33d and the reduced diameter section 33a.

The through hole in the pivot pin holder 31 has upper and lower sections 31a and 31b. The lower section 31b accommodates the body section 33d of the pivot pin 33 for allowing the pin 33 to slide in the vertical direction. In order to inhibit radial rattling of the pivot pin 33, the inner diameter of the lower section 31b may be made only slightly larger than the diameter of the body section 33d of the pivot pin 33, so that the gap between the outer surface of the body section 33d and the inner surface of the lower section 31b is as small as possible.

The upper section 31a of the through hole accommodates the spring 32 therein. The diameter of the upper section 31a is larger than the diameter of the lower section 31b to form the step 33c between the upper and lower sections so that the flange 33b at the upper end of the pivot pin 33 rests on the step 33c for preventing the pin 33 from falling through the lower section 31b.

The upper pivot hinge assembly 30 may be assembled by placing the pivot pin 33 in the lower section 31b of the through hole of the pivot pin holder 31, placing the spring 32 in the upper section 31a, and fixing the pivot pin holder 31 in the upper rail 12 with screws 34.

In this state, the upper end of the through hole is closed with the underside of the attachment portion 12a of the upper rail 12, to which the upper end of the spring 32 abuts. The lower end of the spring 32 abuts the upper face of the flange 33b to urge the pin 33 downward so that the reduced diameter section 33a is pushed into engagement in bushing dent 9a provided in the upper end face of the upper arm 9, in other words, in the upper end of the linking column 11. In this way, the linking column 11 is pivotably supported in the door opening 3, with the pivot pin 30 acting as the pivot axis.

In reverse, the linking column 11 may be detached from the door frame 7 by inserting a tool such as a flathead screwdriver through a gap provided in the upper rail 12, placing the tip of the tool at the step 33c, and pushing the pin 33 up against the downward thrusting force of the spring 32. This makes the pivot pin 33 slide upwards in the lower section 31b to disengage the reduced diameter portion 33a from the dent 9a in the upper arm 9, to thereby allowing the linking column 11 to be disengaged from the lower pivot hinge assembly 40, and removed from the door opening 3.

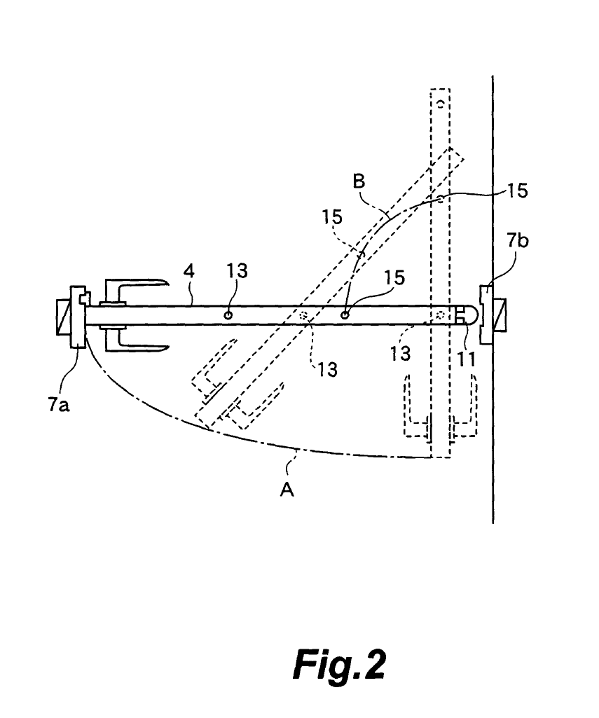

Operation of the folding pivot door assembly 1 is schematically shown in FIG. 2, wherein the folding pivot door assembly 1 in its closed position is shown in solid lines, and the door 1 in its intermediate and opened positions is shown in phantom.

The operation of the folding pivot door assembly 1 basically involves three actions. The linking column 11 with the upper and lower arms 9 and 10 pivots around the upper and lower pivot hinge assemblies 30 and 40 with respect to the door frame 7. The door plate 4 pivots around the upper and lower pivot pins 15 and 16 with respect to the upper and lower arms 9 and 10, i.e., to the linking column 11. The guide member 13 runs along the upper rail 12 to guide the door plate 4. This three actions are combined to reduce the space required for opening and closing of the door.

When the door plate 4 is pulled open from the initial closed position shown in solid lines, the door plate 4 pivots around the upper and lower pivot pints 15 and 16 with respect to the upper and lower arms 9 and 10, and the guide member 13 slides in a straight locus along the upper rail 12, with the shaft 19 (FIG. 5) rotating with respect to the support block 18, while the upper and lower arms 9 and 10 of the column 11 swing in the direction opposite to the motion of the leading edge of the doorplate 4, i.e., swing backwards around the upper and lower pivot hinge assemblies 30 and 40. Thus the leading edge of the door plate 4 moves along the locus A, while the upper pivot pin 15 moves along the locus B in FIG. 2.

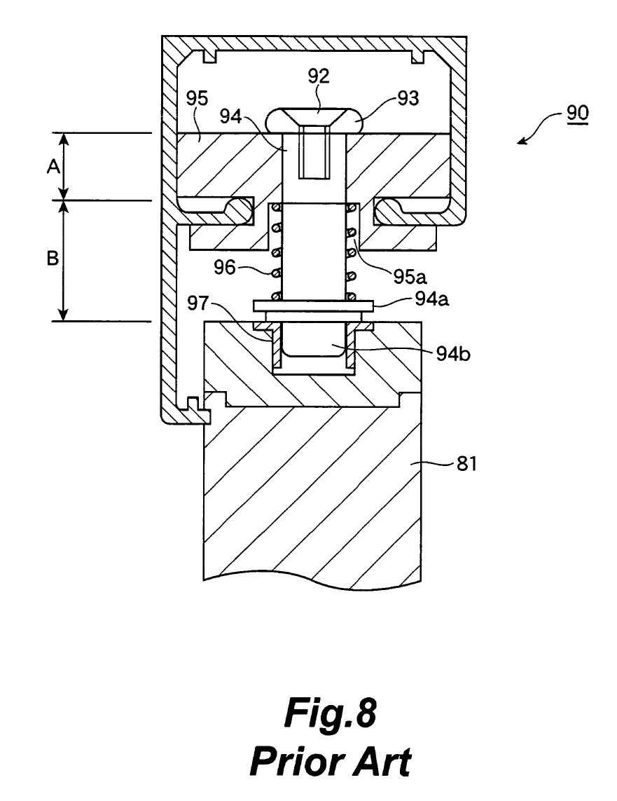

In the upper pivot hinge assembly 30, the pivot pin holder 31 has the through hole having the lower section 31b for accommodating the pivot pin 33 and the upper section 31a for accommodating the spring 32 abutting the flange 33b of the pivot pin 33. Thus, the portion of the pivot pin 33 protruding downwardly from the lower surface of the pivot pin holder 31 is shorter than that of the conventional structure as shown in FIG. 8, which reduces the bending moment applied to the pivot pin 33 compared to that in the conventional structure. That is, the shorter the length of the portion of the pin 33 exposed to the outside of the pivot pin holder 31, the less bending moment is applied to the pivot pin 33 proportionally. Thus even when a horizontal force is applied to the linking column 11 and transmitted via the dent 9a in the upper arm 9 to the reduced diameter section 33a of the pin 33, the bending moment applied to the pivot pin 33 is suppressed due to its short length of exposure. This structure makes the pivot pin 33 hard to be damaged, and improves the durability of the pivot hinge assembly 30 compared to the conventional pivot hinge.

Although the present invention has been described with reference to the preferred embodiment, it should be understood that various modifications and variations can be easilymadebythose skilledin the artwithout departing from the spirit of the invention. Accordingly, the foregoing disclosure should be interpreted as illustrative only and is not to be interpreted in a limiting sense. The present invention is limited only by the scope of the following claims.

What is claimed is:

1. A pivot hinge assembly for pivotably supporting a linking column in a door opening around a pivot axis located near a jamb of a door frame defining the door opening, said linking column pivoting in linkage with a door plate supported in said door opening, said pivot hinge assembly comprising:
a pivot pin acting as a pivot axis for a linking column,
an elastic member urging said pivot pin downwards,
a pivot pin holder having a through hole for accommodating said elastic member and said pivot pin therein, said through hole having a lower section for supporting said pivot pin vertically slidably, and an upper section for accommodating said elastic member, and
a closure for closing an upper end of said through hole,
wherein said elastic member is arranged with its upper end abutting said closure and its lower end abutting an upper face of said pivot pin for urging said pivot pin downward into engagement with a dent provided in an upper end face of said linking column.

2. The pivot hinge assembly of claim 1, wherein said pivot pin has a body section, a flange provided at an upper end of the pin, and reduced diameter section having a diameter smaller than that of said body section in the lower portion of the pin, and wherein said reduced diameter section is urged downwards by the elastic member into engagement with said dent.

3. The pivot hinge assembly of claim 1, wherein said lower section of said through hole in the pivot pin holder has an inner diameter slightly larger than a diameter of said pivot pin accommodated therein.

4. The pivot hinge assembly of claim 1, wherein said upper section of said through hole in the pivot pin holder has an inner diameter larger than an inner diameter of said lower section of the through hole.

5. A folding pivot door assembly having a pivot hinge assembly of claim 1 comprising:
a door plate pivotably supported in a door opening defined by a door frame,
an upper rail fixed on an underside of a header of said door frame,
a linking column having upper and lower arms integrally fixed at its upper and lower ends, respectively, in a cantilever fashion, said upper and lower arms pivotably connected to the upper and lower faces of the door plate in their free end portions, respectively, said linking column pivoting in linkage with the door plate,
upper and lower pivot hinge assemblies for pivotably supporting the linking column in the door opening around a pivot axis located near a jamb of the door frame, and
a guide member fixed to and extending upwardly from the upper face of the door plate, said guide member being slidably supported by said upper rail,
wherein said upper pivot hinge assembly further comprises:
a pivot pin acting as said pivot axis for the linking column,
an elastic member urging said pivot pin downwards,
a pivot pin holder having a through hole for accommodating said elastic member and said pivot pin therein, said through hole having a lower section for supporting said pivot pin vertically slidably, and an upper section for accommodating said elastic member, and
a closure for closing an upper end of said through hole,
wherein said elastic member is arranged with its upper end abutting said closure and its lower end abutting an upper face of said pivot pin for urging said pivot pin downward into engagement with a dent provided in an upper end face of said linking column.

6. The folding pivot door assembly of claim 5, wherein said closure is the header of a door frame.

7. The folding pivot door assembly of claim 5, wherein said closure is the upper rail.
